(19) United States
(12) Patent Application Publication
(10) Pub. No.: US 2008/0188631 A1
(43) Pub. Date: Aug. 7, 2008

(54) Film Coating Liquid

(75) Inventor: Ryoichi Mase, Tokyo (JP)

Correspondence Address: APEX JURIS, PLLC, 12360 LAKE CITY WAY NORTHEAST, SUITE 410, SEATTLE, WA, 98125, US

(73) Assignee: POWER SUPPORT CO., LTD., Tokyo (JP)

(21) Appl. No.: 11/553,440

(22) Filed: Oct. 26, 2006

(51) Int. Cl. C08G 77/00

(52) U.S. Cl. 525/477

(57) ABSTRACT

A film coating liquid that is applied to electronic device screens and thinly and entirely covers and coats the screen surface. The resulted protective film provides excellent scratch resistance, antifouling and dirt or stain resistance.

### BACKGROUND OF THE INVENTION

1. Field of the Invention

This invention relates to a film coating liquid for screens, and more particularly, to a film coating liquid for various types of screens or displays.

2. Description of the Related Arts

One type of conventional screen protective film is described in U.S. RE35,318. It discloses a securable and removable shield in association with such as LCD screens. The shield is removable and replaceable and includes convex peripheral edges to conform the shield to the convex screen with an extending tab formed outwardly of a single corner of the shield to enhance manual grasping thereof. To enhance securement of the shield to the associated screen, a plurality of transparent adhesive strips may be secured to an interior surface of the shield.

Conventional screen protective films generally comprise three separate films. First, there is an actual film sheet, or shield, that is placed on the screen. The protective film usually has a second, removable top film sheet cover that adheres to the protective film and protects the protective film, or shield, during shipping prior to sale and application, and that is peeled off after placing the protective film sheet on the screen. Finally, there is usually an under film sheet that adheres to the underside, or screen attachment side, of the protective film. The protective film has an adhesive surface. The under film adheres to the protective film prior to application. The under film is removed immediately prior to applying the protective film to the screen and then the protective film is adhered to the screen via the adhesive surface.

Conventional screens also need to either be precut by the manufacturers or cut by users to the appropriate size and shape in order to fit the actual screen of the particular electronic device to which they are applied. Also, the process of placing and adhering the film to the screen is not an easy task for an unskilled person because air bubbles and/or dust can easily remain between the film and screen thereby preventing a clean, clear application.

The idea of using a liquid material to coat the screen surface has been utilized in manufacturing facilities; however, such technology requires professional skills and knowledge, large and expensive equipment, and facilities designed specifically for this purpose. No conventional art suggests an effective way to provide a simple product and easy method to use film coating technology.

### SUMMARY OF THE INVENTION

One feature of this invention is to provide a liquid film coating that applies easily to screens such as LCD screens for computers, MPEG players, MP3 players, and PDAs. The liquid is user friendly and can easily be applied by anyone. There is no required training or machinery and therefore it is readily available to the common user.

Another feature is that after application the liquid solidifies and thereafter provides a protective film that covers the screen of the electronic device. The film created and formed by the liquid of this invention provides a scratch resistant surface that seals and protects the electronic device's screen.

Yet another feature of this invention is that unlike the conventional films, the film formed according to this invention does not require any sizing and shaping because of its liquid form. In the present invention, the liquid is simply applied to the entire screen, evenly covering the entire surface. After application the liquid dries and creates a protective film over the entire surface. The resulted film is much thinner than conventional films that are generally around 0.1-0.2 mm thickness.

This invention provides a film coating liquid that is a mixture of silica, fiber and fluorine. Furthermore, the resulted film provides much lower friction coefficient than the conventional film. Lower friction coefficient increases the scratch resistance performance and reduces the surface contamination factor.

### DETAILED DESCRIPTION OF THE INVENTION

This invention is not limited by the examples explained herein. Also, the following explanation uses an example where the liquid is used to form a film on a screen of an electronic device, such as an LCD; however, the usage of the film is not limited to such a surface, and this invention can be employed for use in or with various types of electronic and non-electronic devices or objects.

The liquid can contain silicon fluorine copolymer, glass fiber polymer, silicon surface active agent, and water. The mixture is then applied on an LCD screen. While applying the liquid, small particles of the liquid flows into small scratches in fills them due to the resonance absorption theory. Thereafter, a piece of cloth or a tissue paper may be used to thinly and evenly expand the same to cover the entire screen surface or any appropriate portion of the surface.

The resulted thin film reduces the friction coefficient of the LCD screen surface by one fourth compared to the LCD screen surface without the film. The lower friction coefficient reduces the chance of getting scratched.

Also, the liquid may contain an antistatic agent. Thus, the resultant film coated surface will exhibit antistatic effects.

Finally, the liquid may contain an ultraviolet ray absorbent agent. When included in the liquid the resultant film will exhibit properties of ultraviolet ray absorbency.

It is readily apparent that the above-described embodiments have the advantage of wide commercial utility. It should be understood that the specific form of the invention hereinabove described is intended to be representative only, as certain modifications within the scope of these teachings will be apparent to those skilled in the art. Accordingly, reference should be made to the following claims in determining the full scope of the invention.

What is claimed is:

1. A film coating liquid comprising silicon fluorine copolymer, glass fiber polymer, silicon surface active agent, and water.

2. The film coating liquid according to claim 1, wherein said film coating liquid further comprises an antistatic agent.

3. The film coating liquid according to claim 1, wherein said film coating liquid further comprises ultraviolet ray absorbent agent.

4. The film coating liquid according to claim 1 where the film coating is applied to an electronic device screen.
